(19) United States
(12) Patent Application Publication
(10) Pub. No.: US 2008/0166622 A1
(43) Pub. Date: Jul. 10, 2008

(54) Seal gasket-integrated membrane-electrode assembly and fuel cell

(75) Inventors: Fumishige Shizuku, Komaki-shi (JP); Hiroo Yoshikawa, Susono-shi (JP); Kenji Sato, Susono-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 12/007,434

(22) Filed: Jan. 10, 2008

(30) Foreign Application Priority Data
Jan. 10, 2007 (JP) 2007-002124

(51) Int. Cl. H01M 2/08; H01M 8/02

(52) U.S. Cl. 429/35

(57) ABSTRACT

A seal gasket-integrated membrane-electrode assembly includes: a power generation portion that undergoes electrochemical reactions between hydrogen and oxygen; and a seal gasket provided on an outer peripheral edge of the power generation portion. The first center in the thickness direction of the power generation portion is offset toward an anode electrode of the membrane-electrode assembly from the second center in the thickness direction of the seal gasket.

### INCORPORATION BY REFERENCE

The disclosure of Japanese Patent Application No. 2007-2124 filed on Jan. 10, 2007 including the specification, drawings and abstract is incorporated herein by reference in its entirety.

### BACKGROUND OF THE INVENTION

1. Field of the Invention

The invention relates to a seal gasket-integrated membrane-electrode assembly and a fuel cell.

2. Description of the Related Art

Generally, in a fuel cell, a fuel gas and an oxidizing gas (hereinafter, referred to as “reactant gases”) are respectively supplied to an anode electrode and a cathode electrode of a membrane-electrode assembly (hereinafter, simply referred to as “MEA”), and thereby the fuel cell generates electricity through the electrochemical reactions (fuel cell reactions) thereof. The MEA is sandwiched by separators, and gas channels for supplying the reactant gases are provided on the separators and between the separators and the respective electrodes. For example, Japanese Patent Application Publication No. 2006-216492 (hereinafter, referred to as “JP-A-2006-216492”) proposes various technologies related to fuel cells that have such gas channels.

In general, the amount supplied to the fuel cell and pressure, for example, of the fuel gas are different from those of the oxidizing gas. For example, in a fuel cell to which hydrogen is supplied as the fuel gas and air is supplied as the oxidizing gas, because the oxygen concentration in the air is generally about 20%, the power generation efficiency may be improved by making the air amount supplied larger than the hydrogen amount supplied, taking into account the reaction amounts between hydrogen and oxygen. However, JP-A-2006-216492, for example, does not describe a construction that may make the pressure loss of a gas channel provided on a cathode electrode side (i.e., a cathode gas channel) smaller than the pressure loss of a gas channel provided on an anode electrode side (i.e., an anode gas channel).

### SUMMARY OF THE INVENTION

The invention provides a seal gasket-integrated membrane-electrode assembly and a fuel cell that make the pressure loss of a cathode gas channel smaller than the pressure loss of a anode gas channel.

A seal gasket-integrated membrane-electrode assembly according to the first aspect of the invention includes: a power generation portion that undergoes electrochemical reactions between hydrogen and oxygen; and a seal gasket that is provided on an outer peripheral edge of the power generation portion. A first center in a thickness direction of the power generation portion is offset toward an anode electrode provided in the membrane-electrode assembly from a second center in the thickness direction of the seal gasket.

According to the first aspect of the invention, the sectional area of the gas channel provided on the anode electrode side may be reduced by the amount by which the center of the power generation portion of the membrane-electrode assembly in the thickness direction is offset, and the sectional area of the gas channel provided on the cathode electrode side may be increased by the same amount. Therefore, the pressure loss may be adjusted in accordance with the sectional areas of the gas channels that are changed in accordance with the offset amount.

A fuel cell according to the second aspect of the invention includes: a membrane-electrode assembly that provides with a power generation portion undergoing electrochemical reactions between hydrogen and oxygen; a seal gasket that is provided on an outer peripheral edge of the power generation portion; separators that sandwiches the membrane-electrode assembly therebetween; a fuel gas channel layer that is disposed between an anode electrode of the membrane-electrode assembly and one of the separators, and through which a fuel gas is spread over the anode electrode; and an oxidizing gas channel layer that is disposed between a cathode electrode of the membrane-electrode assembly and the other of the separators, and through which an oxidizing gas is spread over the cathode electrode. The fuel gas channel layer is formed thinner than the oxidizing gas channel layer.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIGS. 1A and 1B are schematic diagrams showing a construction of a fuel cell stack in accordance with a first embodiment of the invention;

FIG. 2 is a schematic diagram showing the seal gasket-integrated membrane-electrode assembly according to the first embodiment of the invention;

FIGS. 3A and 3B are sectional views of the seal gasket-integrated membrane-electrode assembly shown in FIG. 2;

FIG. 4 is a schematic diagram showing an anode plate that constitutes a separator;

FIG. 5 is a schematic diagram showing a cathode plate that constitutes the separator;

FIG. 6 is a schematic diagram showing an intermediate plate that constitutes the separator;

FIGS. 7A to 7C are illustrative diagrams for illustrating the flows of hydrogen and air;

FIGS. 8A and 8B are sectional views showing a seal gasket-integrated membrane-electrode assembly according to a comparative example for the first embodiment;

FIGS. 9A and 9B are sectional views showing the seal gasket-integrated membrane-electrode assembly according to the second embodiment;

FIGS. 10A and 10B are schematic diagrams showing a seal gasket-integrated membrane-electrode assembly according to a third embodiment;

FIG. 11 is a sectional view showing the seal gasket-integrated membrane-electrode assembly according to the third embodiment;

FIG. 12 is a perspective view showing a construction of a gas channel-forming member of a fourth embodiment;

FIG. 13 is an illustrative diagram showing a construction of the gas channel-forming member of the fourth embodiment;

FIG. 14 is an illustrative diagram showing a construction of the gas channel-forming member of the fourth embodiment;

FIG. 15 is an illustrative diagram showing a construction of the gas channel-forming member of the fourth embodiment.

### DETAILED DESCRIPTION OF EMBODIMENTS

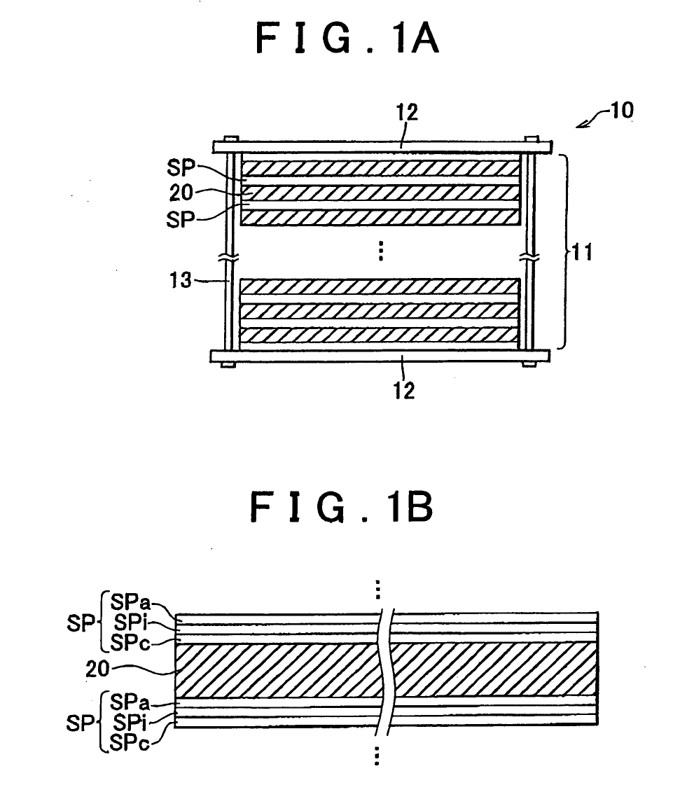

FIG. 1A is a schematic diagram showing a construction of a fuel cell stack according to a first embodiment of the invention. A fuel cell stack 10 is a solid polymer fuel cell that is supplied with a fuel gas and an oxidizing gas, and that generates electric power through electrochemical reactions (i.e., fuel cell reactions). Concretely, hydrogen is supplied as the fuel gas, and a high-pressure air containing oxygen is supplied as the oxidizing gas. Incidentally, the fuel cell stack is not limited to that of the solid polymer fuel cell. The invention is applicable to various types of fuel cells.

The fuel cell stack 10 includes a stack body 11 that is formed by stacking a plurality of seal gasket-integrated MEA 20 (described later) that are individually sandwiched between separators SP which are described later. The stack body 11 is sandwiched between two end plates 12 with receiving a load due to a fastening member 13.

FIG. 1B is a schematic diagram showing a seal gasket-integrated MEA 20 and two separators SP that sandwich the seal gasket-integrated MEA 20. Each of the separators SP is a three-layer structure that is formed by an anode plate SPa, a cathode plate SPc and an intermediate plate Spi, which is sandwiched between the anode plate Spa and the cathode plate SPc. The anode plate SPa is in contact with an anode electrode side of the seal gasket-integrated MEA 20, and the cathode plate SPc is in contact with a cathode electrode side of the seal gasket-integrated MEA 20. Each of the separators Sp may be constructed of an electroconductive member such as carbon or metal.

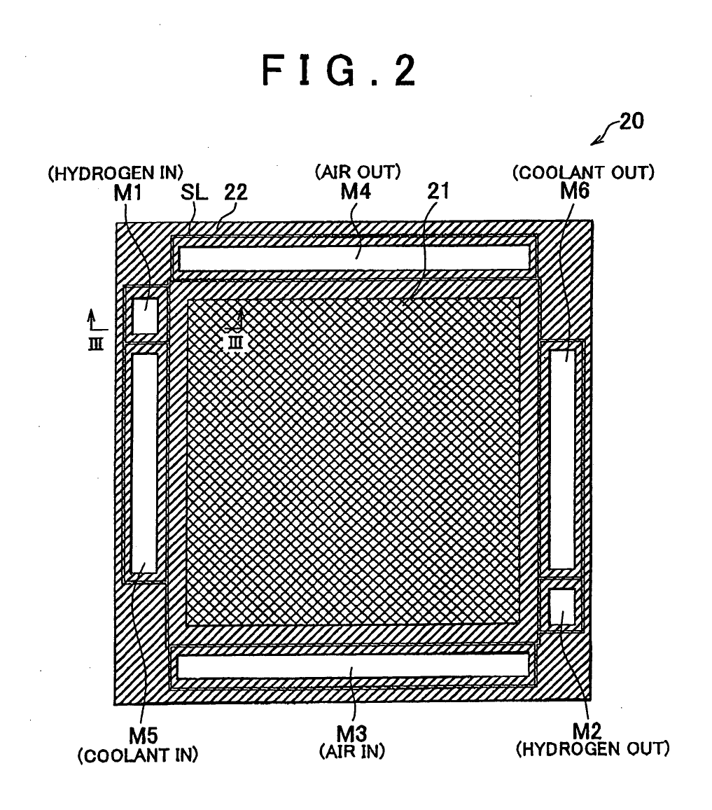

FIG. 2 is a schematic diagram showing an anode electrode-side surface of a seal gasket-integrated MEA 20. The cathode electrode side of the seal gasket-integrated MEA 20 has substantially the same construction as the anode electrode side thereof, and the illustration thereof is omitted.

The seal gasket-integrated MEA 20 is a generally rectangular member having a power generation portion 21 in which the fuel cell reactions are conducted, and a seal gasket 22 provided on an outer peripheral edge of the power generation portion 21. The seal gasket 22 is provided with manifold holes M1 to M6 that are penetration holes for respectively performing the supply and the discharge of hydrogen, air, a coolant, etc. Concretely, the seal gasket 22 has a construction as follows.

Hydrogen is supplied through the manifold hole M1, and an anode-discharging gas containing the hydrogen that has not been consumed during the fuel cell reactions is discharged through the manifold hole M2. Air is supplied through the manifold hole M3, and a cathode-discharging gas containing the oxygen that has not been consumed or the water that has been produced during the reactions is discharged through the manifold hole M4. A coolant such as water for cooling the heat of the fuel cell stack 10 that has been produced during the electric power generation is supplied through the manifold hole M5, and discharged through the manifold holes M6.

The manifold hole M1 for supplying hydrogen is provided diagonally with respect to the manifold hole M2 for discharging hydrogen across the power generation portion 21 on a diagonal line. The manifold hole M5 for supplying coolant is provided opposite with respect to the manifold hole M6 for discharging coolant across the power generation portion 21. In addition, the manifold holes M1, M2, M5 and M6 are provided along the long sides of the seal gasket-integrated MEA 20. Besides, the manifold hole M3 for supplying oxygen is provided opposite with respect to the manifold hole M4 for discharging oxygen across the power generation portion 21. The manifold holes M3 and M4 are each provided in a generally elongated rectangular shape along the short sides of the seal gasket-integrated MEA 20. The number of manifold holes M3 provided in the seal gasket-integrated MEA 20 is one, and the number of the manifold holes M4 provided therein is also one. Alternatively, the manifold holes M1 to M6 may be provided in other constructions and arrangements.

When the seal gasket-integrated MEA 20 is sandwiched by separators SP, one side of the seal gasket 22 contacts the anode plate SPa and the other side of the seal gasket 22 contacts the cathode plate SPc. In a contact surface of the seal gasket 22 with each of the separators SP, seal lines SL (shown by double lines in FIG. 2) are formed with lips (i.e., protruded portions). The seal lines SL are separately formed surrounding each of the manifold holes M1 to M6 and the power generation portion 21. Therefore, a fluid is prevented from leaking out of the regions surrounded by the seal lines SL. Incidentally, the seal gasket 22 is constructed of an insulating seal member such as silicon rubber.

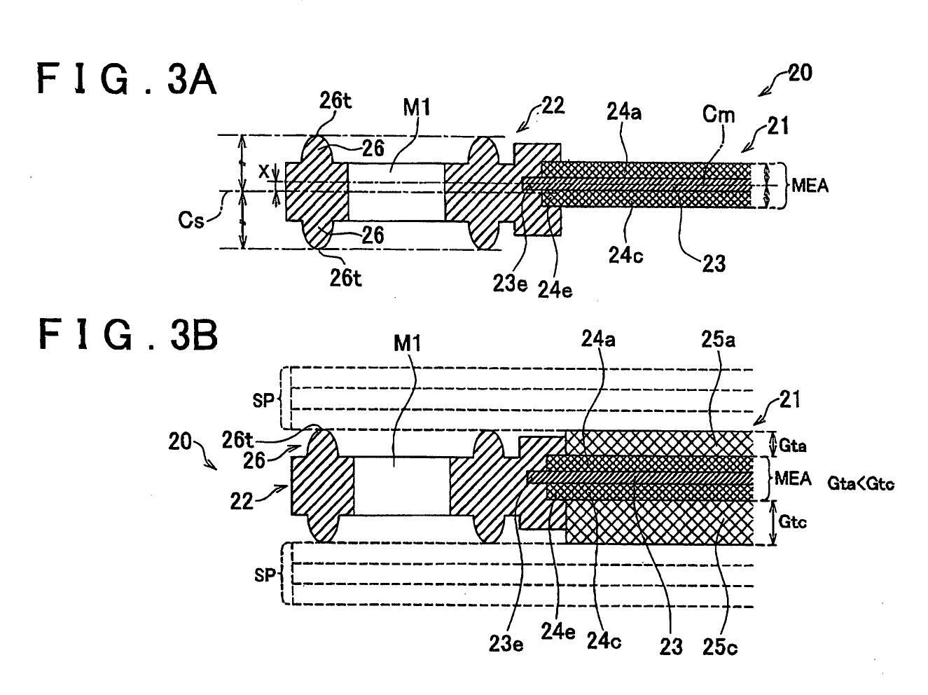

FIG. 3A is a sectional view of a seal gasket-integrated membrane-electrode assembly taken along the line III-III of FIG. 2. The power generation portion 21 includes an electrolyte membrane 23 that has good proton conductivity under the wet state. The electrolyte membrane 23 is sandwiched by an anode electrode 24a and a cathode electrode 24c, thus forming the membrane-electrode assembly (MEA).

The two electrode layers 24a, 24c may be constructed of a carbon paper or the like, and serves as gas diffusion layers that spread the supplied reactant gases over the entire electrolyte membrane 23. Besides, each of contact surfaces of the two electrode layers 24a, 24c with the electrolyte membrane 23 is provided with a catalyst layer (not shown) that is loaded with a catalyst for accelerating the fuel cell reactions. Platinum. (Pt), for example, may be used as the catalyst material.

Hereinafter, an outer peripheral edge of the electrolyte membrane 23 is referred to as a “membrane end portion 23e”, and an outer peripheral edge of each of the two electrode layers 24a, 24c is referred to as an “electrode layer end portion 24e”. The membrane end portion 23e is protruded from the electrode layer end portions 24e. The seal gasket 22 is formed so as to cover the membrane end portion 23e and the electrode layer end portions 24e. Due to this construction, the MEA is retained by the seal gasket 22 while cross leak near the electrode layer end portions 24e is restrained from occurring. The “cross leak” herein refers to a phenomenon in which hydrogen moves to the cathode side without being consumed during the fuel cell reactions in the power generation of a fuel cell.

Both sides of the seal gasket 22 are provided with lips 26 that are protruded portions. These lips 26 form the seal lines SL (FIG. 2) as described above. An apical portion 26 of each of the lips 26 is pressed by the separator SP. As shown in FIG. 3A, the lips 26 are provided on both the anode electrode-side surface and the cathode electrode-side surface, symmetrically across a center Cs of the seal gasket 22 in the thickness direction. The “center Cs of the seal gasket 22 in the thickness direction” herein indicates the center of the distance between the top portion 26t on the anode electrode side and the top portion 26t on the cathode electrode side.

The seal gasket 22 is formed so that the center Cm of the membrane-electrode assembly MEA in the thickness direction is offset by a distance X toward the anode electrode side from the center Cs of the seal gasket 22 in the thickness direction, as shown in FIG. 3A. The “center Cm of the membrane-electrode assembly MEA” indicates a center of the distance between an outer surface of the anode electrode 24a (i.e., the surface that is not in contact with the electrolyte membrane 23) and an outer surface of the cathode electrode 24c (i.e., the surface that is not in contact with the electrolyte membrane 23). In addition, the center Cs of the seal gasket 22 in the thickness direction is the center in the thickness direction when the seal gasket 22 is not receiving force from outside, that is, when the lips 26 are not deformed due to compression or the like. Hereinafter, the aforementioned distance X is referred to as “offset value X”. It suffices that the offset value X be greater than zero; for example, the offset value X may be determined from the ratio between the amount of oxygen and the amount of hydrogen supplied per unit time.

FIG. 3B is a diagram schematically showing the seal gasket-integrated MEA 20 that has been sandwiched by separators SP (shown by dashed lines). FIG. 3B is substantially the same as FIG. 3A, except that the top portions 26t of the lips 26 are pressed by the separators SP and that gas channel layers 25a, 25c described later are provided.

The anode gas channel layer 25a and the cathode gas channel layer 25c are disposed between the two electrode layers 24a, 24c and the separators SP, respectively. The two gas channel layers 25a, 25c have a function of spreading the reactant gases over the entire two electrode layers 24a, 24c. Besides, because inner surfaces of the gas channel layers 25a, 25c are in contact with the two electrode layers 24a, 24c and the separators SP, the gas channel layers 25a, 25c may conduct the generated electricity to the separators SP. The gas channel layers 25a, 25c may be constructed of a porous material having electro-conductivity such as carbon or sintered metal.

As shown in FIG. 3B, as for the seal gasket-integrated MEA 20, the center Cm of the membrane-electrode assembly MEA may also be offset toward the anode electrode side from the center Cs of the seal gasket 22 in the thickness direction when the seal gasket-integrated MEA 20 is sandwiched by the separators SP (i.e., when the seal gasket-integrated MEA 20 is being used in a fuel cell). This allows the thickness Gta of the anode gas channel layer 25a to be thinner than the thickness Gtc of the cathode gas channel layer 25c (i.e., Gta<Gtc). That is, the pressure loss of a gas channel provided on the cathode electrode side may be made smaller than that of a gas channel provided on the anode electrode side.

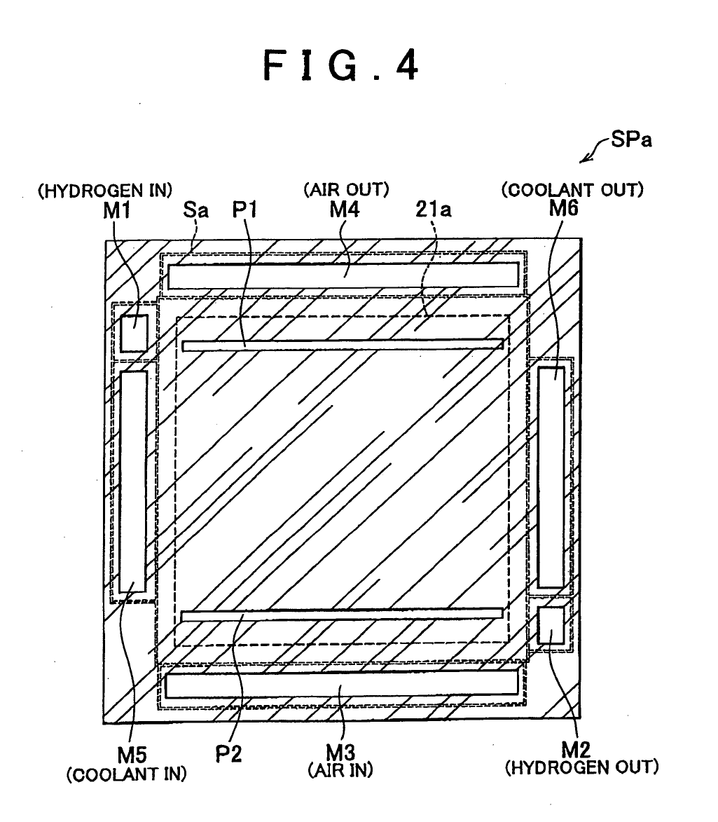

FIG. 4 schematically shows the anode plate SPa that constitutes the separators SP. In FIG. 4, a power generation portion region 21a corresponding to the power generation portion 21 of the seal gasket-integrated MEA 20 when the fuel cell stack 10 is constructed is shown by single dashed lines, and seal regions Sa that are sites of contact with the seal lines SL of the seal gasket 22 are shown by double dashed lines.

The anode plate SPa is provided with manifold holes M1 to M6 that are penetration holes, similarly to the seal gasket-integrated MEA 20. A hydrogen inflow hole P1 is provided near the manifold hole M1 for supplying hydrogen, and a hydrogen outflow hole P2 is provided near the manifold hole M2 for discharging hydrogen. The hydrogen inflow hole P1 and the hydrogen outflow hole P2 are elongated rectangular penetration holes that are provided in the power generation portion region 21a, extending along the short sides of the power generation portion region 21a. Through the hydrogen inflow hole P1 and the hydrogen outflow hole P2, hydrogen is supplied into or discharged out of the anode electrode side of the seal gasket-integrated MEA 20. The flow of hydrogen will be detailed later. In addition, the anode plate SPa may have another construction instead of the above-described construction.

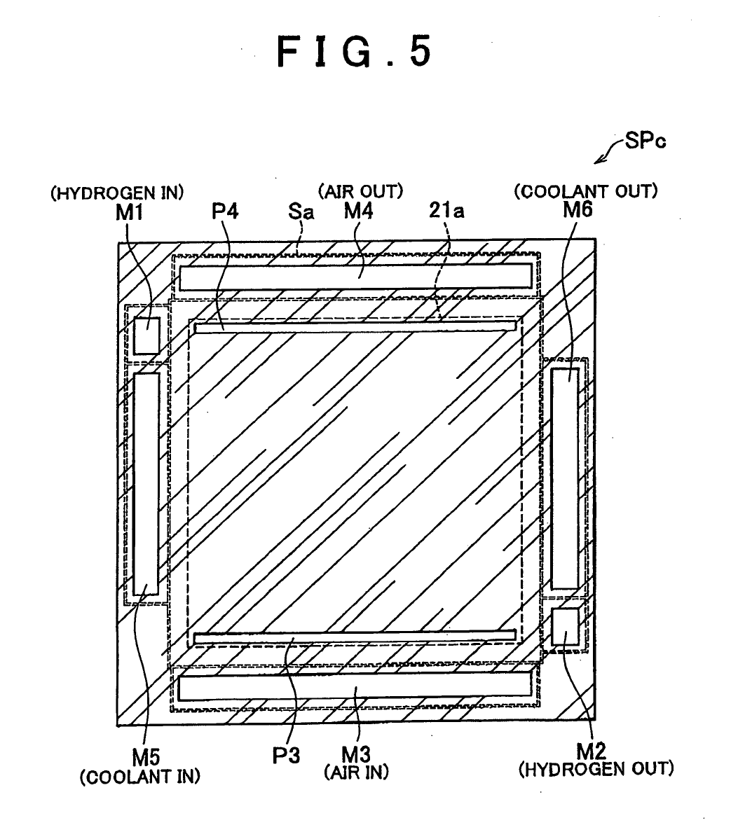

FIG. 5 schematically shows the cathode plate SPc. The cathode plate SPc has similar construction to the anode plate SPa in FIG. 4, except that the hydrogen inflow hole P1 and the hydrogen outflow hole P2 are replaced by an oxygen inflow hole P3 and an oxygen outflow hole P4.

Each of the oxygen inflow hole P3 and the oxygen outflow hole P4 is elongated rectangular penetration hole that is respectively provided in parallel with the manifold hole M3 for supplying oxygen and the manifold hole M4 for discharging oxygen. The oxygen inflow hole P3 and the oxygen outflow hole P4 are provided in the power generation portion region 21a. Through the oxygen inflow hole P3 and the oxygen outflow hole P4, air is supplied into or discharged out of the cathode electrode side of the seal gasket-integrated MEA 20. The flow of air will be detailed later. In addition, the cathode plate SPc may also have another construction instead of the above-described construction.

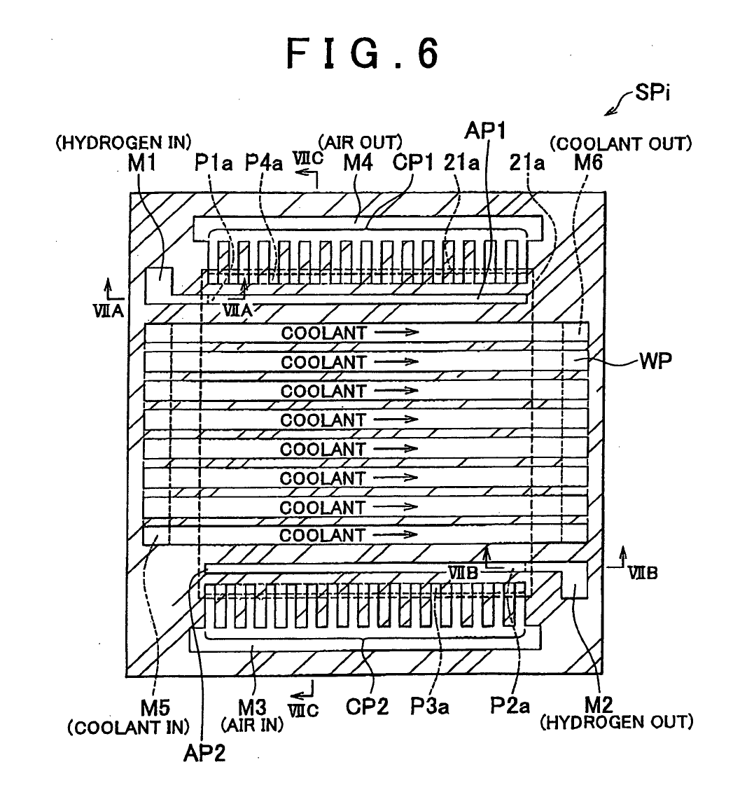

FIG. 6 schematically shows the intermediate plate SPi. In FIG. 6, a power generation portion region 21a is shown by single dashed lines as in FIGS. 4 and 5. Besides, communication regions P1a, P2a that lie over the hydrogen inflow hole P1 and the hydrogen outflow hole P2 of the anode plate SPa when the separators SP are constructed, and communication regions P3a, P4a that lie over the oxygen inflow hole P3 and the oxygen outflow hole P4 of the cathode plate SPc when the separators SP are constructed are shown by dashed lines.

The intermediate plate SPi, similarly to the other plates SPa, SPc, is provided with hydrogen manifold holes M1 to M2 and oxygen manifold hole M3 to M4. The intermediate plate SPi is provided with two anode channels AP1, AP2 penetrating therethrough. The first anode channel AP1 is linked in communication with the manifold hole M1 for supplying hydrogen, and is provided so as to lie substantially over the communication region P1a. The second anode channel AP2 is linked in communication with the manifold hole M2 for discharging hydrogen, and is provided so as to lie substantially over the communication region P2a.

The intermediate plate SPi is provided with two rows CP1, CP2 of cathode channels that are comb-like arrangements of slits penetrating through the intermediate plate SPi. The first cathode channel row CP1 is linked, at an end thereof, in communication with the manifold hole M4 for discharging oxygen, and is provided at another end thereof so as to lie over the communication region P4a. The second cathode channel row CP2 is linked, at an end thereof, in communication with the manifold hole M3 for supplying oxygen, and is provided at another end thereof so as to lie over the communication region P3a. Detailed description of the flows of hydrogen and oxygen will be described later.

The intermediate plate SPi is also provided with a plurality of coolant channels WP penetrating therethrough. The coolant channels WP are provided so that when the intermediate plate SPi is sandwiched by the plates SPa, SPc, the coolant channels WP communicate with the coolant manifold holes MT, M6 provided in the two plates SPa, SPc. Therefore, when a coolant is supplied from outside the fuel cell stack 10 to the manifold hole M5, a portion of the coolant branches into the coolant channels WP and passes therethrough as shown by arrows in FIG. 6, and reaches the manifold hole M6 for discharging coolant accompanied by the heat produced along with the electric power generation. It is preferable that the coolant channels WP be provided so as to cool the entire power generation portion region 21a.

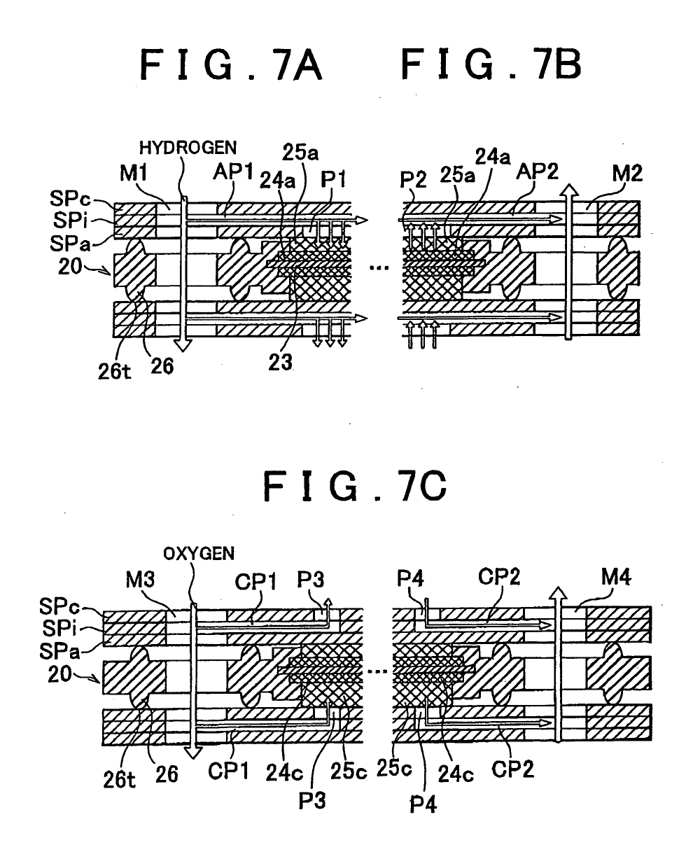

Next, with reference to FIGS. 7A to 7C, the flows of hydrogen and air in the fuel cell stack 10 will be described. FIGS. 7A to 7C are each a sectional view of a given seal gasket-integrated MEA 20 sandwiched by separators SP in an assembled fuel cell stack 10, taken at a site on the seal gasket-integrated MEA 20. Detailed description will be given below.

FIGS. 7A and 7B are sectional views at sites that correspond to the section on the line VIIA-VIIA and the section on the line VIIB-VIIB, showing channels of hydrogen. A portion of the hydrogen supplied from outside the fuel cell stack 10 to the manifold hole M1 flows into the first anode channel AP1 provided in the intermediate plate SPi as shown by arrows in FIG. 7A. After that, hydrogen reaches the anode gas channel layer 25a via the hydrogen inflow hole P1 provided in each anode plate SPa. On the other hand, the anode exhaust gas, as shown by arrows in FIG. 7B, flows through the second anode channel AP2 from the hydrogen outflow hole P2, and reaches the manifold hole M2 for discharging hydrogen, and then is discharged to the outside of the fuel cell stack 10.

FIG. 7C is a sectional view taken at a site that corresponds to the section on the line VIIC-VIIC shown in FIG. 6, showing channels of air. A portion of the oxygen supplied from outside the fuel cell stack 10 to the manifold hole M3 flows into the first cathode channel row CP1 provided in the intermediate plate SPi, as shown by arrows in FIG. 7C. After that, oxygen reaches the cathode gas channel layer 25c via the oxygen inflow hole P3 provided in each cathode plate SPc. On the other hand, the cathode exhaust gas flows through the second cathode channel row CP2 from the oxygen outflow hole P4, and reaches the manifold hole M4 for discharging oxygen, and then is discharged to the outside of the fuel cell stack 10.

Via the foregoing paths, the reactant gases are supplied to the gas channel layers 25a, 25c, and the exhaust gases are guided to the outside. Incidentally, in this specification, the paths of hydrogen that include the anode channels AP1, AP2 provided in the separators SP and the anode gas channel layers 25a are called “the anode gas channels”. Besides, the paths of air that include the cathode channel rows CP1, CP2 provide in the separators SP and the cathode gas channel layers 25c are called “cathode gas channels”.

The diffusion coefficient of hydrogen is greater than the diffusion coefficient of oxygen, which is contained in air. Therefore, even if the thickness of the anode gas channel layer 25a is less than the thickness of the cathode gas channel layer 25c as described above, hydrogen can sufficiently diffuse within the anode gas channel layer 25a, so that hydrogen may be spread over the entire anode electrode 24a. On the other hand, the cathode gas channel layer 25c is formed so as to be thicker than the anode gas channel layer 25a. Therefore, channels that allow oxygen to sufficiently diffuse within the cathode gas channel layer 25c are secured, so that oxygen may be spread over the cathode electrode 24c.

Furthermore, as described with reference to FIG. 3, because the thickness of the cathode gas channel layer 25c is made greater, the pressure loss of the cathode gas channel is correspondingly reduced to a greater extent than the pressure loss of the anode gas channel. As a result, the amount of oxygen supplied to the cathode electrode 24c may be increased. Besides, in the case where the water produced on the cathode electrode side by the fuel cell reactions is discharged, the discharging characteristic may be improved. Therefore, the power generation efficiency of the fuel cell stack 10 improves. In addition, while the thickness of the cathode gas channel layer 25c is made greater, the thickness of the anode gas channel layer 25a is made correspondingly smaller. Therefore, when the cathode gas channel layer 25c is assembled, the increased thickness of the cathode gas channel layer 25c does not result in an increase in the volume of the fuel cell stack 10. Besides, the following effects can also be obtained.

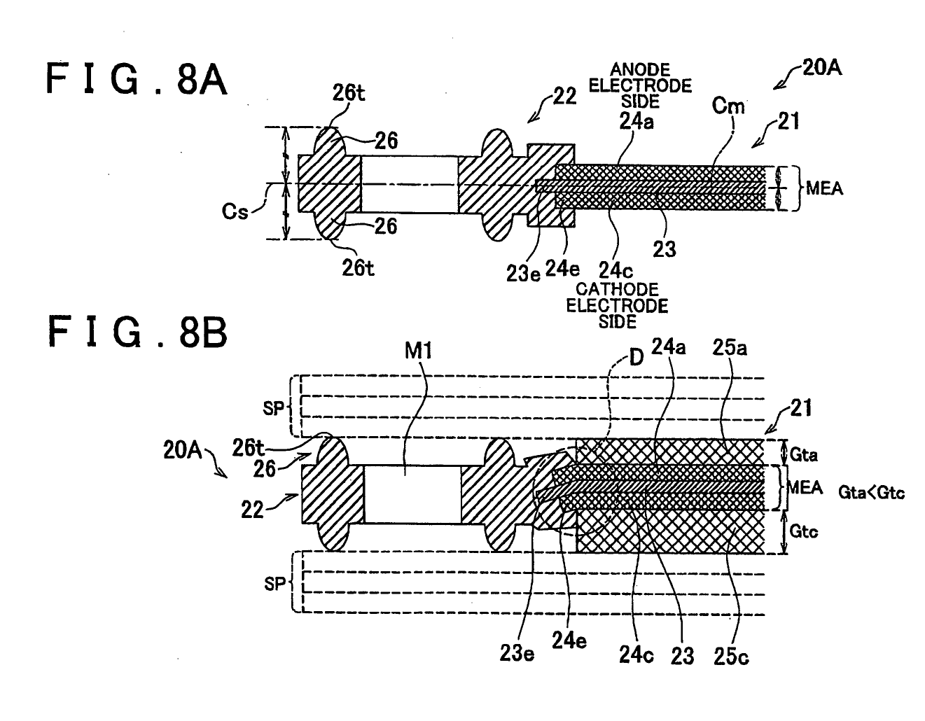

FIG. 8A is a sectional view showing a construction of a seal gasket-integrated MEA 20A as a comparative example for the first embodiment of the invention. The seal gasket-integrated MEA 20A shown in FIG. 8A is substantially the same as the seal gasket-integrated MEA 20 shown in FIG. 3A, except that the center Cm of the membrane-electrode assembly MEA is not offset from the center Cs of the seal gasket 22. Besides, FIG. 8B shows a state in which the power generation portion 21 of the seal gasket-integrated MEA 20A is provided with gas channel layers 25a, 25c that have the same thicknesses as those described with reference to FIG. 3B, and is sandwiched by separators SP.

Even this construction can attain effects as described above due to the difference in thickness between the gas channel layers 25a, 25c. However, in a state in which the seal gasket-integrated MEA 20A is sandwiched by the separators SP as shown by a region D circled by a dashed line in FIG. 8B, strain occurs in the end portions of the membrane-electrode assembly MEA, leading to a possibility of degradation of the electrolyte membrane 23 or the electrode layers 24a, 24c. Besides, extra strain occurs to the cathode gas channel layer 25c.

In this manner, according to the seal gasket-integrated MEA 20 of the first embodiment, the pressure loss of the anode gas channel and the cathode gas channel may be adjusted by adjusting the offset value X between the center Cm of the membrane-electrode assembly MEA and the center Cs of the seal gasket 22 in the thickness direction. Therefore, the supply and discharge of the fluids becomes able to be efficiently performed in the fuel cell, so that the power generation efficiency of the fuel cell may be improved.

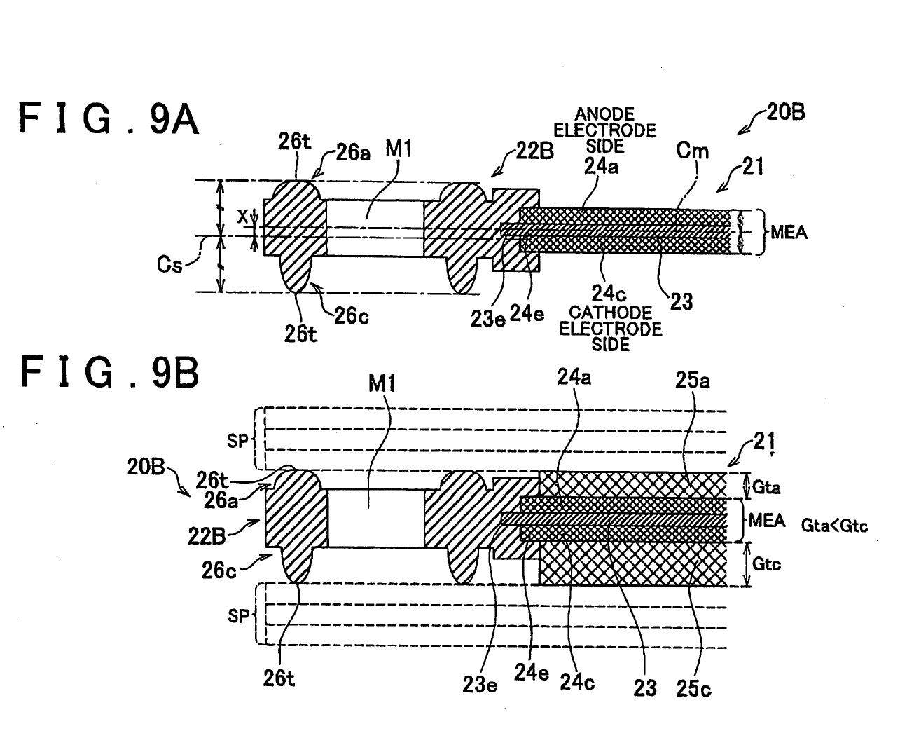

FIG. 9A is a sectional view showing a construction of a seal gasket-integrated membrane-electrode assembly as a second embodiment of the invention. FIG. 9A is substantially the same as FIG. 3A, except that the shape of a seal gasket 22B is different from the shape of the seal gasket 22 of the first embodiment. FIG. 9B is an illustrative diagram schematically showing a state in which the seal gasket-integrated MEA 20B is sandwiched by separators SP. FIG. 9B is substantially the same as FIG. 3B, except that the seal gasket-integrated MEA 20 in the first embodiment is replaced by a seal gasket-integrated MEA 20B. In addition, the constructions of the separator SP and the fuel cell stack 10 are substantially the same as in the first embodiment.

As may be understood from FIG. 9A as well, lips 26c provided on the cathode electrode side of the seal gasket-integrated MEA 20B are protruded higher than the lips 26a provided on the anode electrode side. Due to this construction, the seal gasket-integrated MEA 20B is in a state in which the center Cm of the membrane-electrode assembly MEA is offset from the center Cs of the seal gasket 22B in the thickness direction to the anode electrode side, as in the seal gasket-integrated MEA 20 of the first embodiment.

That is, the construction of the second embodiment, similarly to the construction of the first embodiment, allows the thickness of the cathode gas channel layer 25c to be greater than the thickness of the anode gas channel layer 25a. Therefore, the power generation efficiency of the fuel cell may be improved.

However, it is preferable that the configurations of the lips 26a, 26c be designed so that when the lips 26a, 26c are pressed, the compression ratios of the lips 26a, 26c become equal. This manner of construction prevents the pressures on the lips 26a, 26c from becoming one-sided, and therefore can restrain the degradation of the lips 26a, 26c.

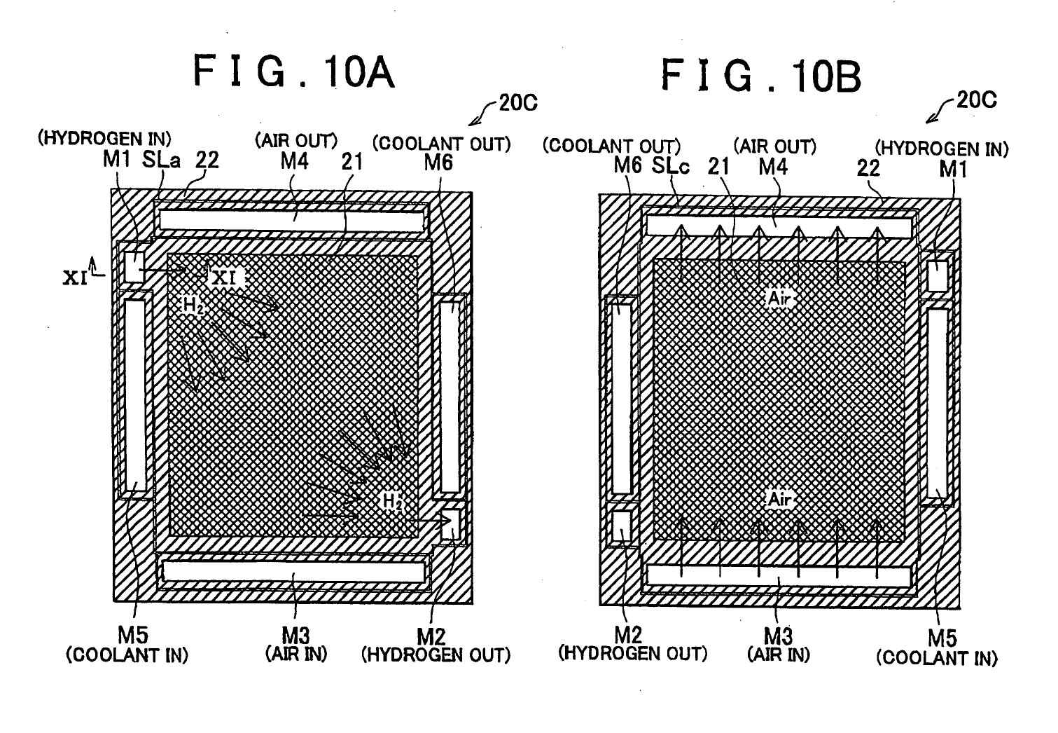

FIGS. 10A and 10B are schematic diagrams showing a construction of a seal gasket-integrated membrane-electrode assembly as a third embodiment of the invention. FIG. 10A shows an anode electrode side of the seal gasket-integrated MEA 20C. This seal gasket-integrated MEA 20C is substantially the same as the seal gasket-integrated MEA 20 of the first embodiment, except that seal lines SLa on the anode electrode side are formed surrounding the hydrogen manifold holes M1, M2 and the power generation portion 21 as a single region.

FIG. 10B shows a cathode electrode side of the seal gasket-integrated MEA 20C. Seal lines SLc on the cathode electrode side are formed surrounding the oxygen manifold holes M3, M4 and the power generation portion 21 as a single region.

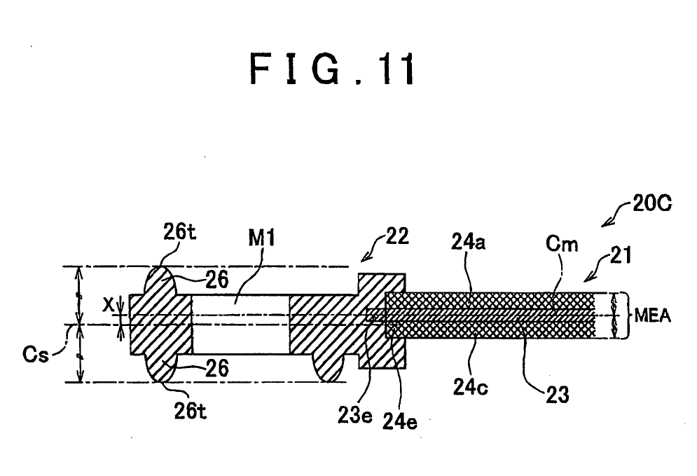

FIG. 11 is a sectional view of the seal gasket-integrated MEA 20C taken along the line XI-XI in FIG. 10A. FIG. 11 is substantially the same as FIG. 3A, except that because the seal lines SLa on the anode electrode side are formed surrounding the hydrogen manifold hole M1 and the power generation portion 21 as a single region, a lip 26 is not provided between the power generation portion 21 and the manifold hole M1 on the anode electrode side.

As may be understood from FIGS. 10A and 10B and FIG. 11 as well, in this seal gasket-integrated MEA 20C, the anode electrode-side seal lines SLa and the cathode electrode-side seal lines SLc are not provided symmetrically across the center Cs of the seal gasket 22C in the thickness direction. Even in this construction, the cathode gas channel layer 25c and the anode gas channel layer 25a that are different in thickness may be disposed on the power generation portion 21, similarly to the first embodiment (FIG. 3B). Therefore, similarly to the first embodiment, the efficiency in the supply and discharge of the fluids in the fuel cell becomes better, and the power generation efficiency of the fuel cell improves.

Due to this manner of construction, the fluids flow between the manifold holes M1 to M4 and the power generation portion 21 as shown by arrows in FIGS. 10A and 10B. That is, according to the construction of the seal gasket-integrated MEA 20C, the gases may be supplied and discharged, without employing channels AP1, AP2, CP1, CP2 provided in the intermediate plate SPi of each separator SP as in the first embodiment. Therefore, it is possible to adopt separators other than the three-layer type separators, such as the separators SP of the first embodiment.

The gas channel layers 25a, 25c employed in the first to third embodiments can also be constructed of a gas channel-forming member 30 described below.

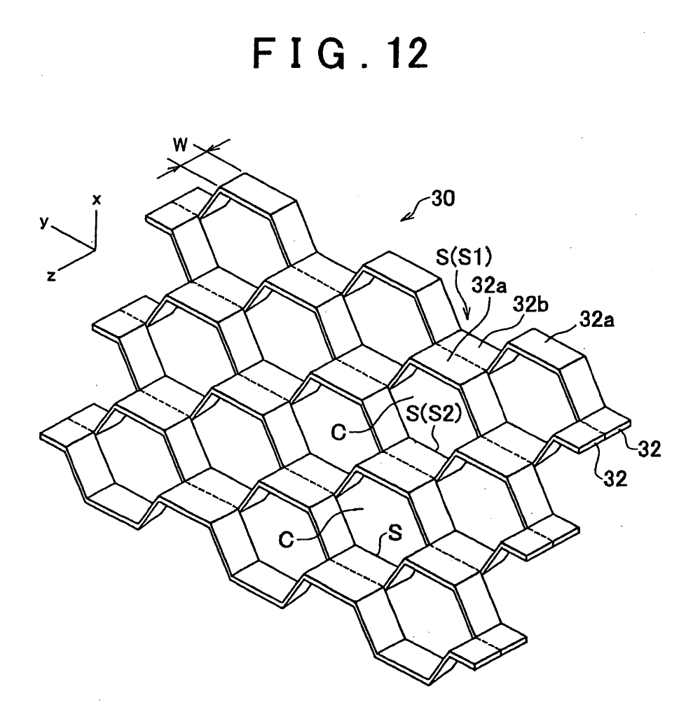

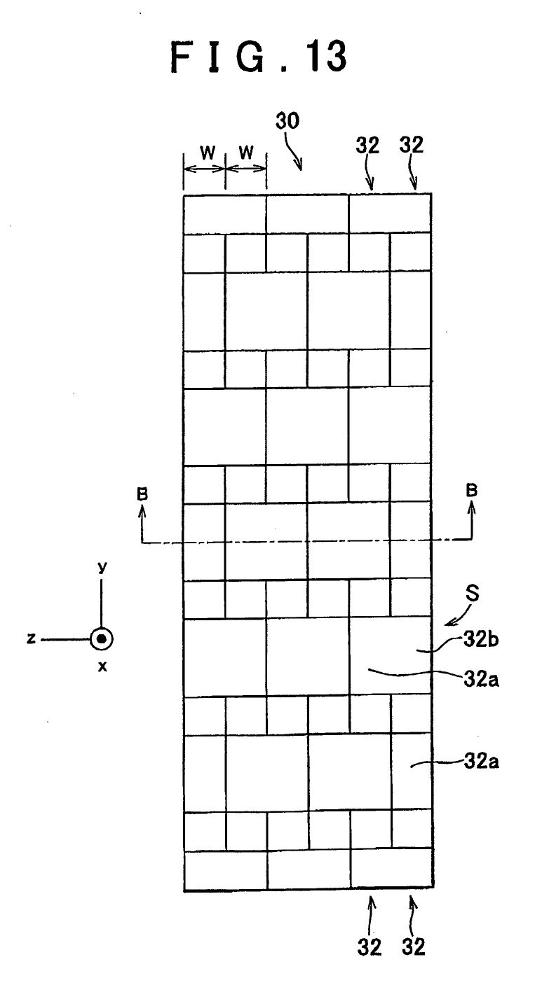

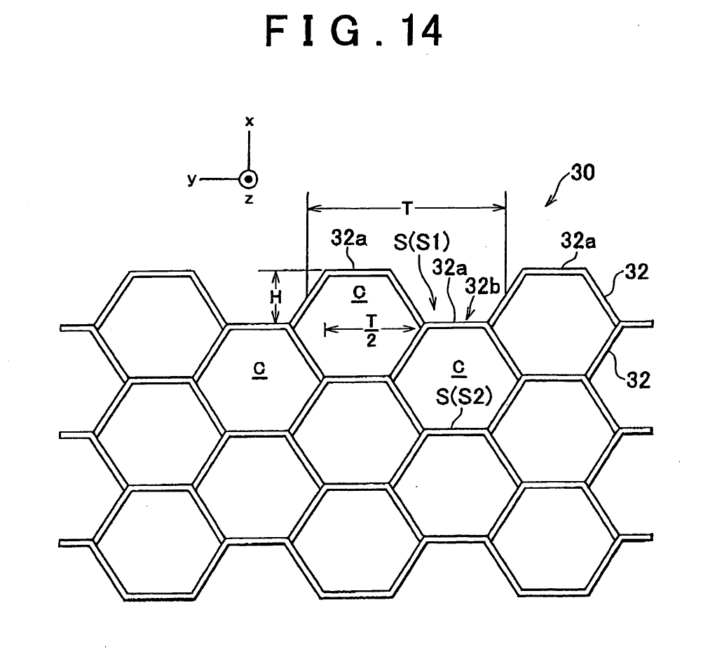

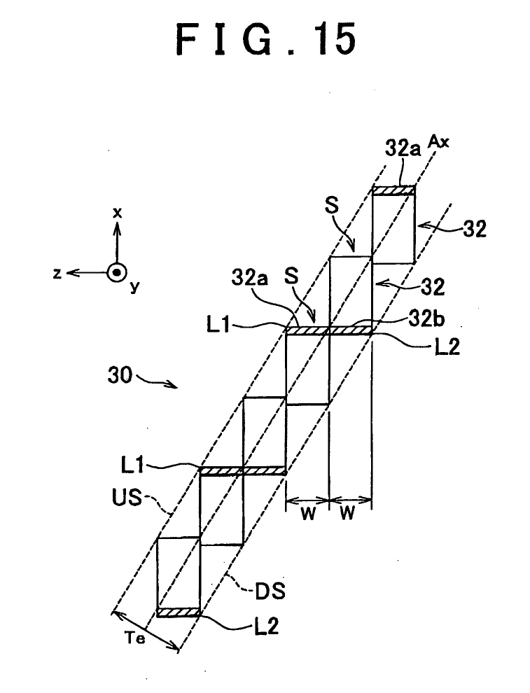

FIG. 12 is a perspective view showing a gas channel-forming member 30 in a fourth embodiment. FIG. 13 is a plan view of the gas channel-forming member 30, and FIG. 14 is a front view of the gas channel-forming member 30. FIG. 15 is a sectional view of the gas channel-forming member 30 taken on the plane B-B shown in FIG. 13. As shown in FIGS. 12 to 15, a basic structure of the gas channel-forming member 30 is a corrugated plate portion 32 in which ridge portions 32a and trough portions 32b continuously alternate with each other. The gas channel-forming member 30 has a construction in which a plurality of corrugated plate portions 32 is interconnected. The corrugated plate portions 32 have the same shape and also have the same lateral width W. Incidentally, the ridge portions 32a have a shape in which the opening portion is larger in size than the top side (the bottom side in the case of the trough portions 32b), that is, a shape in which the flanking sides are inclined to the perpendicular direction.

Dashed lines in FIG. 12 are provided for conveniently showing division between two adjacent corrugated plate portions 32. In FIGS. 12 to 14, the number of corrugated plate portions 32 interconnected is six.

The interconnection of a plurality of corrugated plate portions 32 will be described below. Assuming that the direction of the amplitude of the ridge portions 32a and the trough portions 32b is the direction of an x-axis, and the direction of the extension of the ridge portions 32a and the trough portions 32b is the direction of a y-axis (perpendicular to the direction of the x-axis), corrugated plate portions 32 are sequentially connected along the direction of a z-axis perpendicular to the direction of the x-axis and to the direction of the y-axis. The interconnection between two adjacent corrugated plate portions 32 is made so that the trough portions 32b of one of the corrugated plate portions 32 connect to the ridge portions 32a of the other corrugated plate portion 32, as shown in FIG. 13. In detail, the aforementioned one corrugated plate portion 32 is an inverse of the other corrugated plate portion 32 in terms of reverse and obverse so that the trough portions 32b are converted into the ridge portions 32a, and the ridge portions 32a are converted into the trough portions 32b. Then, the trough portions 32b of the one corrugated plate portion 32 are connected to the ridge portions 32a of the other.

As a result of the foregoing connection, when seen in a front view as shown in FIG. 14, two adjacent corrugated plate portion 32, 32 are in a positional relationship in which they are shifted from each other by half the cycle T of the ridge portions 32a and the trough portions 32b in the direction of the y-axis, and by the amplitude H of the ridge portions 32a and the trough portions 32b in the direction of the x-axis. The connection portions between the trough portions 32b of a corrugated plate portion 32 and the ridge portions 32a of an adjacent corrugated plate portion 32 form single planes (hereinafter, referred to as “the connection planes”) S. Therefore, as may be seen from FIG. 14, a hexagonal penetration hole C is formed between a connection plane S1 and an adjacent connection plane S2 formed by the next trough portion 32b and the next ridge portion 32a. Hexagonal penetration holes C are arranged in such a zigzag pattern as to form a so-called honeycomb shape. Incidentally, in the fourth embodiment, the aforementioned hexagonal shape is an equilateral and equiangular hexagon having equal length sides and equal angles of 120°. The length of each side of the hexagon is 0.26 [mm]. The lateral width w of each corrugated plate portion 32 is 0.3 [mm]. As a modification of the fourth embodiment, the hexagonal shape may be of a hexagon other than the equilateral and equiangular hexagon.

In the illustration shown in FIGS. 12 to 15, the number of repetitions of the ridge portions 32a and the trough portions 32b (hereinafter, referred to simply as “the ridge-trough frequency”) is three, and the number of corrugated plate portions 32 interconnected is six. Therefore, as shown in FIGS. 12 and 14, the number of hexagonal penetration holes C formed is 3+2+3+2+3=13. Incidentally, as for the gas channel-forming member 30, the gas channel-forming member 30 in reality has a construction in which the ridge-trough frequency is about 350° and the number of corrugated plate portions 32 interconnected is about 250 and the number of hexagonal penetration holes C is about 87000.

The gas channel-forming member 30 constructed as described above is disposed between the seal gasket-integrated membrane-electrode assembly and the separators SP as described above in conjunction with the embodiments. The manner of disposing the gas channel-forming member 30 will next be described.

As shown in FIG. 15, in the gas channel-forming member 30 constructed as described above, the connection planes S formed by the trough portions 32b and the ridge portions 32a of adjacent corrugated plate portions 32 are aligned in one direction. The direction of the alignment is represented by the direction of a line that connects the center points of the connection planes S, and is the direction of an AX axis in FIG. 15. Because the corrugated plate portions 32 have the same lateral width W, sides L1 of the connection planes S located at one of the two opposite sides in the direction of the z-axis (the left side in FIG. 15) are on a plane US parallel to the AX axis (hereinafter, termed the upper plane US). The opposite sides L2 of the connection planes S (at the right side in the drawing) are on a plane DS parallel to the AX axis (hereinafter, termed the bottom plane DS). That is, the upper plane US and the bottom plane DS are parallel to each other. The gas channel-forming member 30 is disposed between the cathode side of the seal gasket-integrated MEA 20 and the separator SP so that the upper surface US contacts the surface of the cathode side of the seal gasket-integrated membrane-electrode assembly and the bottom surface DS contacts the surface of the separator SP.

In other words, the gas channel-forming member 30 is disposed (stacked) between the cathode side of the seal gasket-integrated membrane-electrode assembly and the separator SP so that the direction of the upper surface US and the bottom surface DS is parallel to the cathode-side surface of the seal gasket-integrated membrane-electrode assembly (or the surface of the separator SP). Incidentally, because the upper plane US and the bottom plane DS are parallel to the direction of the AX axis, which is the direction of the alignment of the connection planes S, it can also be said that the gas channel-forming member 30 is disposed between the cathode side of the seal gasket-integrated membrane-electrode assembly and the separator SP so that the direction of the AX axis, which is the direction of the alignment of the connection planes S, is parallel to the cathode-side surface of the seal gasket-integrated membrane-electrode assembly (or to the surface of the separator SP).

Incidentally, the thickness of the gas channel-forming member 30 is the distance Te between the upper surface US and the bottom surface DS. The thickness of the gas channel-forming member 30 disposed on the cathode electrode side is greater than the thickness of the gas channel-forming member 30 disposed on the anode electrode side.

While the invention has been described with reference to example embodiments thereof, it is to be understood that the invention is not limited to the described embodiments or constructions. To the contrary, the invention is intended to cover various modifications and equivalent arrangements as follows. In addition, while the various elements of the example embodiments are shown in various combinations and configurations, other combinations and configurations, including more, less or only a single element, are also within the spirit and scope of the invention.

In the foregoing embodiments, the gas channel layers are disposed between the electrode layers 24a, 24c and the separators SP. Alternatively, the gas channel layers may not be provided. For example, gas channels may be formed by gas channel grooves provided in the contacting surfaces of the separators SP with the electrode layers 24a, 24c. Even in this construction, the pressure loss of the cathode gas channel may be reduced because the sectional area of the cathode gas channel is increased by the amount of the offset value X.

Furthermore, in the foregoing embodiments, the same materials are adopted for the anode gas channel layer 25a and the cathode gas channel layer 25c. Alternatively, the anode gas channel layer 25a and the cathode gas channel layer 25c may also be formed of different materials. For example, it is permissible to adopt the cathode gas channel layer 25c whose material has a greater porosity than the anode gas channel layer 25a. Thus, in addition to the thickness of the gas channel layer, the pressure loss of the cathode gas channel having the greater porosity may be further lessened.

The seal gasket-integrated membrane-electrode assembly of the invention may be realized in various forms, for example, a fuel cell, a fuel cell system that includes such fuel cells, a vehicle equipped with such a fuel cell system, etc.

What is claimed is:

1. A seal gasket-integrated membrane-electrode assembly comprising:
a power generation portion that undergoes electrochemical reactions between hydrogen and oxygen; and
a seal gasket that is provided on an outer peripheral edge of the power generation portion,
wherein a first center in a thickness direction of the power generation portion is offset toward an anode electrode provided in the membrane-electrode assembly from a second center in the thickness direction of the seal gasket.

2. The seal gasket-integrated membrane-electrode assembly according to claim 1, wherein the first center in the thickness direction of the power generation portion is a center of a distance between an outer surface of the anode electrode and an outer surface of a cathode electrode provided in the power generation portion.

3. The seal gasket-integrated membrane-electrode assembly according to claim 1, wherein the first center is offset toward the anode electrode from the second center even when the membrane-electrode assembly is being installed in a fuel cell.

4. The seal gasket-integrated membrane-electrode assembly according to claim 2, wherein:
a first seal line is formed on one surface of the seal gasket, and a second seal line is formed on the other surface the seal gasket; and
the first seal line and the second seal line are provided at opposite positions across the second center of the seal gasket in the thickness direction.

5. The seal gasket-integrated membrane-electrode assembly according to claim 4 wherein:
the first seal line is formed surrounding a fuel gas manifold hole provided in the seal gasket and the power generation portion as one region; and
the second seal line is formed surrounding an oxidizing gas manifold hole provided in the seal gasket and the power generation portion as one region.

6. The seal gasket-integrated membrane-electrode assembly according to claim 4, wherein:
the first seal line is formed by a first lip portion that is protruded from one surface of the seal gasket; and
the second seal line is formed by a second lip portion that is protruded from the other surface of the seal gasket.

7. The seal gasket-integrated membrane-electrode assembly according to claim 6, wherein the first lip portion has the same height as the second lip portion.

8. The seal gasket-integrated membrane-electrode assembly according to claim 6, wherein the second lip portion has the greater height than the first lip portion.

9. The seal gasket-integrated membrane-electrode assembly according to claim 8, wherein each of the first lip portion and the second lip portion is formed into a predetermined shape such that the first lip portion has the same compression ratio as the second lip portion when the membrane-electrode assembly is being installed in a fuel cell.

10. The seal gasket-integrated membrane-electrode assembly according to claim 7, wherein the first lip portion and the second lip portion are provided symmetrically across the second center of the seal gasket in the thickness direction.

11. The seal gasket-integrated membrane-electrode assembly according to claim 6, wherein the second center of the seal gasket in the thickness direction is a center of a distance between apical portions of the first lip portion and the second lip portion.

12. The seal gasket-integrated membrane-electrode assembly according to claim 1, wherein an offset value by which the first center is offset toward the anode electrode from the second center is determined by a ratio between an amount of hydrogen and an amount of oxygen that are supplied to the power generation portion per unit time.

13. A fuel cell comprising:
a membrane-electrode assembly that provides with a power generation portion undergoing electrochemical reactions between hydrogen and oxygen;
a seal gasket that is provided on an outer peripheral edge of the power generation portion;
separators that sandwiches the membrane-electrode assembly therebetween;
a fuel gas channel layer that is disposed between an anode electrode of the membrane-electrode assembly and one of the separators, and through which a fuel gas is spread over the anode electrode; and
an oxidizing gas channel layer that is disposed between a cathode electrode of the membrane-electrode assembly and the other of the separators, and through which an oxidizing gas is spread over the cathode electrode,
wherein the fuel gas channel layer is formed thinner than the oxidizing gas channel layer.

14. The fuel cell according to claim 13, wherein the fuel gas channel layer is made thinner than the oxidizing gas channel layer in accordance with an offset value by which the first center is offset toward the anode electrode from the second center.

15. The fuel cell according to claim 13, wherein each of the fuel gas channel layer and the oxidizing gas channel layer is formed of a porous member.

16. The fuel cell according to claim 13, wherein:
each of the fuel gas channel layer and the oxidizing gas channel layer has a plurality of corrugated plate portions in which ridge portions and trough portions continuously alternate in one direction, the plurality of corrugated plate portions being interconnected along another direction that is orthogonal to the one direction and orthogonal to an amplitude direction of the ridge portions and the trough portions;
the trough portions of one of the adjacent corrugated plate portions is interconnected to the ridge portions of the other corrugated plate portions, and thereby connection planes of the trough portions and the ridge portions forms into stepped meshes; and
a planar direction of each of the corrugated plate portions is inclined by a predetermined angle with respect to an electrode plane of the membrane-electrode assembly.
